(19) United States
(12) Patent Application Publication
(10) Pub. No.: US 2022/0048706 A1
(43) Pub. Date: Feb. 17, 2022

(54) DEBRIS CONTAINMENT BAG

(71) Applicant: Joel Hermosillo Magallenes, Las Vegas, NV (US)

(72) Inventor: Joel Hermosillo Magallenes, Las Vegas, NV (US)

(21) Appl. No.: 17/198,236

(22) Filed: Mar. 10, 2021

Related U.S. Application Data
(60) Provisional application No. 63/103,608, filed on Aug. 17, 2020.

(51) Int. Cl. B65F 1/00; A01G 20/43

(52) U.S. Cl. CPC B65F 1/0006; B65F 2220/1063; B65F 2240/138; A01G 20/43

(57) ABSTRACT

A debris containment bag; the debris containment bag provides an all-in-one tool used to help gather, transport and cover debris and other materials in a safe and effective manner. The debris containment bag includes a large, durable, and flexible canvas sheet having a strap system that may be used to collect and secure debris and other items in a plurality of configurations.

### CROSS-REFERENCE TO RELATED APPLICATION(S)

The present application is related to and claims priority to U.S. Provisional Patent Application No. 63/103,608 filed Aug. 17, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of tarps of existing art and more specifically relates to material containment systems including tarps.

### RELATED ART

There are many different types of tarps on the market. Typically, conventional tarps are used to wrap up debris such as yard clippings and leaves, and to carry the debris somewhere for storage or disposal. Tarps are also often used to cover things, like yard debris, in the back of pickup. Additionally, there are burlap bags and other bags used to gather debris. However, workers will often load the bag to a point where they are difficult to move so now two people have to struggle to transport it or they have to get a secondary piece of equipment, like a dolly to move the loaded tarp. A suitable solution is desired.

U.S. Pat. No. 7,785,008 to Darrell Arthur Schoenig, et. al. relates to a planar loaded operably conformable material containment system. The described planar loaded operably conformable material containment system includes a BigFoot™ Bag material containment system which provides a material container (2) having a flexible layer (26) which can be established in a substantially planar configuration (3) on a support surface (4) for loading material (5) and which operably conforms by closure (15) to provide an enclosed space (20) to contain the loaded material (5).

### SUMMARY OF THE INVENTION

In view of the foregoing disadvantages inherent in the known tarp art, the present disclosure provides a novel debris containment bag. The general purpose of the present disclosure, which will be described subsequently in greater detail, is to provide a large sheet of durable fabric for collection, transport and disposal of debris in volume.

A debris containment bag is disclosed herein. The debris containment bag includes a flexible canvas sheet preferably having an octagonal profile. The flexible canvas sheet includes a first-side for placing at least one item for collection and transport and a second-side comprising a strap system. The strap system is provided on the second-side of the flexible canvas sheet and includes at least four bungee-style securing straps positioned along vertical and horizontal borders of the flexible canvas sheet. The strap system further includes a first adjustable length securing strap, a second adjustable length securing strap, and a pair of backpack-shoulder straps. The strap system is configured to secure the flexible canvas sheet in a folded condition forming an inner volume for transport of the at least one item within the flexible canvas sheet. The flexible canvas sheet is foldable into a plurality of configurations. The debris containment bag may be used to collect foliage clippings, debris, trash, and other items.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a debris containment bag, constructed and operative according to the teachings of the present disclosure.

FIG. 1 is a perspective view of the debris containment bag during an ‘in-use’ condition, according to an embodiment of the disclosure.

FIG. 2 is a top perspective view of the debris containment bag of FIG. 1, according to an embodiment of the disclosure.

FIG. 3 is a perspective view of a strap system of the debris containment bag of FIG. 1, according to an embodiment of the present disclosure.

FIG. 4 is a perspective view of the debris containment bag during an ‘in-use’ condition, according to an embodiment of the disclosure.

FIG. 5 is a perspective view of the debris containment bag during an ‘in-use’ condition, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a tarp and more particularly to a debris containment bag as used to improve the collection, transport, and disposal of debris and other items.

Generally, the debris containment bag provides an all-in-one tool used to help gather, transport and cover debris and other materials in a safe and effective manner. The debris containment bag includes a large, durable, and flexible canvas sheet having a strap system that may be used to collect and secure debris and other items for transport. The debris containment bag may be made in multiple varieties for specific uses and/or for specific trades, such as but not limited to a landscaping and litter pick-up.

In a most preferred embodiment, the debris containment bag is a flexible canvas sheet in oblong octagonal shape, measuring approximately seventy-two inches in maximum length by forty-eight inches in maximum width (72″×48″) when in an open and flat condition. Grommets are featured in even pattern offset about an outer border of the flexible canvas sheet. In the center of this same plane of the sheet is a two-wheeled axle. An arced rectangular cover plate, made of durable plastic, covers the two-wheeled axle. Both above and below the two-wheeled axle are individual storage pouches. Next to the vertical walls of one of these pouches are a pair of backpack-shoulder straps. Projecting horizontally from a top and a bottom hem of this same shoulder-strap-bearing pouch are securing straps with spring-loaded securing buckles.

The debris containment bag may be folded in various ways to secure debris, not just in bag format. For instance, it may be rolled around long twigs and branches. In this version the debris containment bag takes on an oblong shape versus a bag shape. The apparatus can be folded to function like a backpack style pouch. Additionally, the flexible canvas sheet may be used as a tarp to cover a truck bed to ensure debris cannot fall out of the truck. The debris containment bag may also be used as a shading piece before its use to collect debris. In a non-limiting example, the cords and/or straps of the debris containment bag can be secured upon trees directly near the area the user is raking debris in order to create shade, and the debris containment bag can later be removed from the trees for ground placement in order to collect and remove that debris.

The debris containment bag can be made of various materials of applicability, such as but not limited to canvas, tarpaulin, burlap, woven polyester, and any combination of these and other suitable materials. The debris containment bag can be made in various sizes and shapes. In a preferred embodiment, the flexible canvas sheet measures a maximum length of approximately seventy-two inches and a maximum width of approximately forty-eight inches. The debris containment bag may include stakes, mountable through the grommets, that allow it to be secured upon the ground while in use to collect clippings and debris. In such variation, the debris containment bag may include a separate pouch for the storage of the stakes. The debris containment bag may be made in variations that do not include wheels, and/or that do not include a pair of backpack-shoulder straps, and/or that do not include both wheels and a pair of backpack-shoulder straps.

The debris containment bag may be used in a variety of configurations. A first method of using the debris containment bag is as follows: A user may open the debris containment bag and lay it flat upon a surface such as the ground, ensuring the wheel member and the pair of backpack-shoulder straps are facing the ground. The user may then gather debris, such as twigs, leaves and trash, and deposit it directly on this open plane. When finished, or when an assumed maximum volume is collected, the user may then fold and close the debris containment bag using the strap system to seal the debris containment bag and any contents. To transport the debris containment bag, the user may carry it by hand using one of the handles. If too heavy or inconvenient for hand transport, the user may carry it upon his or her back using the pair of backpack-shoulder straps. If too heavy or inconvenient for back transport, the user may simply roll the debris containment bag and its contents via the wheel member.

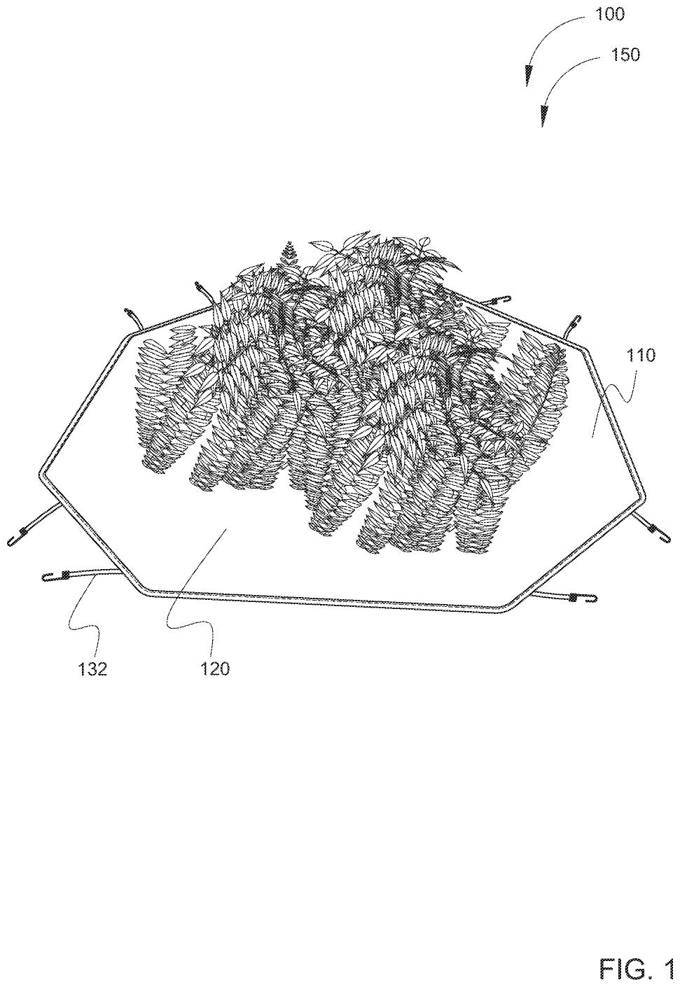

Referring now more specifically to the drawings by numerals of reference, there is shown in FIGS. 1-5, various views of a debris containment bag 100.

FIG. 1 shows a debris containment bag 100 during an ‘in-use’ condition 150, according to an embodiment of the present disclosure. Here, the debris containment bag 100 allows large amounts of debris to be securely, quickly, and safely collected and transported. As illustrated, the debris containment bag 100 may include a flexible canvas sheet 110 having an octagonal profile. The flexible canvas sheet 110 includes a first-side 120 for placing at least one item for transport and a second-side 112 comprising a strap system 130. The strap system 130 is configured to secure the flexible canvas sheet 110 in a folded condition forming an inner volume for transport of the at least one item within the flexible canvas sheet 110. The flexible canvas sheet 110 is foldable into a plurality of configurations. The debris containment bag 100 may be used to collect foliage clippings, debris, trash, and other items.

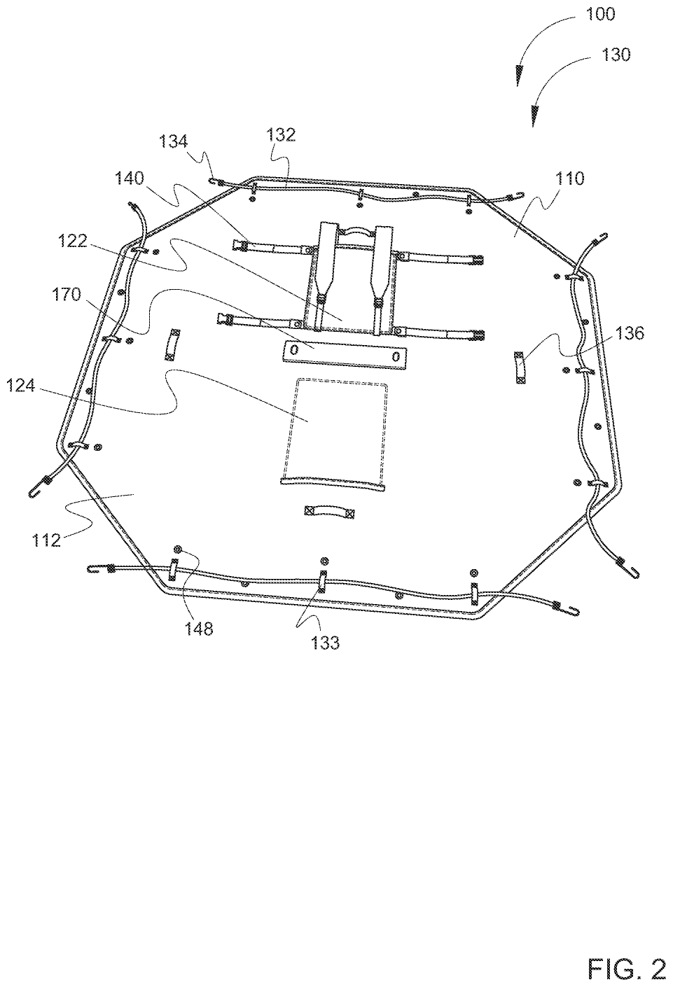

FIG. 2 shows the debris containment bag 100 of FIG. 1, according to an embodiment of the present disclosure. As above, the debris containment bag 100 may include the flexible canvas sheet 110 comprising the first-side 120 and the second-side 112. As shown, the flexible canvas sheet 110 comprises an octagonal profile in a preferred embodiment. The strap system 130 is provided on the second-side 112 of the flexible canvas sheet 110 and includes at least four bungee-style securing straps 132 positioned along vertical and horizontal borders of the flexible canvas sheet 110. The at least four bungee-style securing straps 132 are elasticized and each feature fastener hooks 134 on their end-portions. The at least four bungee-style securing straps 132 are supported by a series of support strap loops 133. A plurality of grommets 148 are positioned along an outer perimeter of the flexible canvas sheet 110. The plurality of grommets 148 are staggered and equidistantly spaced. The plurality of grommets 148 are configured to receive one of the fastener hooks 134 of the at least four bungee-style securing straps 132. The strap system 130 further includes a first adjustable length securing strap 140, a second adjustable length securing strap 142, and a pair of backpack-shoulder straps 160.

The flexible canvas sheet 110 further includes a wheel member 164 positioned at a center portion of the flexible canvas sheet 110. The wheel member 164 includes a first-wheel 166 and a second-wheel 168 hosted on an axle. The wheel member 164 further comprises a cover plate 170. The first-wheel 166 and the second-wheel 168 partially extend through the cover plate 170. In a preferred embodiment, the cover plate 170 comprises a curved profile. The curved profile of the cover plate 170 makes the debris containment bag 100 easier to move and slide over grassy, graveled, and other rough terrains. As illustrated, the second-side 112 further comprises a first storage pouch 122 positioned proximal to a top edge of the wheel member 164 and a second storage pouch 124 positioned along a bottom edge of the wheel member 164. The second-side 112 further comprises at least one handle 136 having a loop profile to assist a user with carrying and transporting the debris containment bag 100 with ease. In a preferred embodiment, four of the at least one handles 136 are provided on the second-side 112 of the flexible canvas sheet 110.

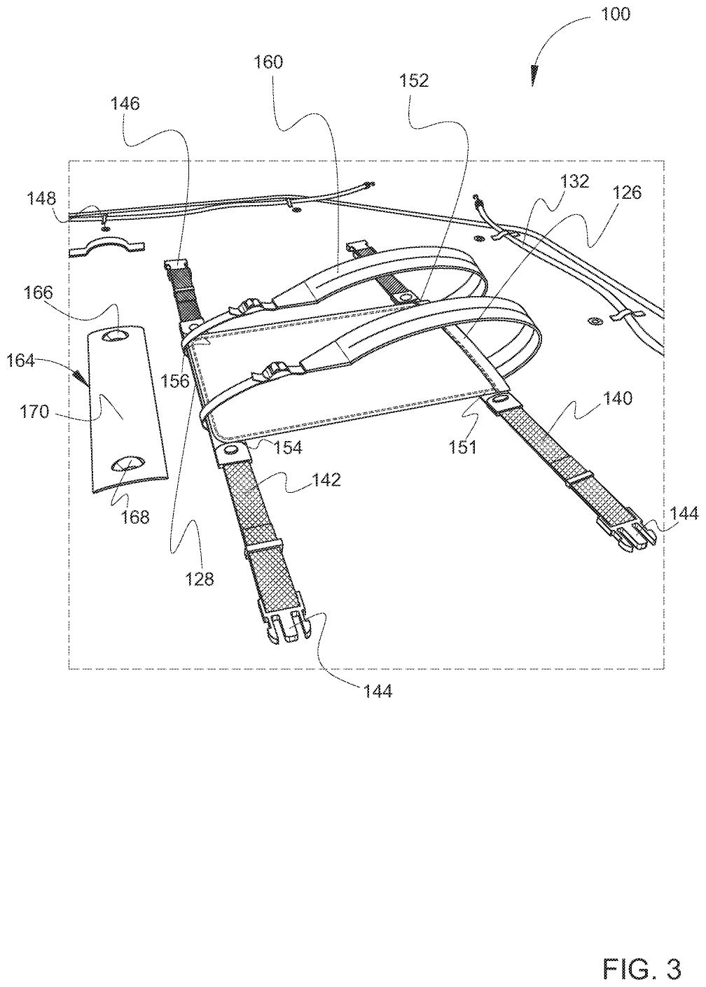

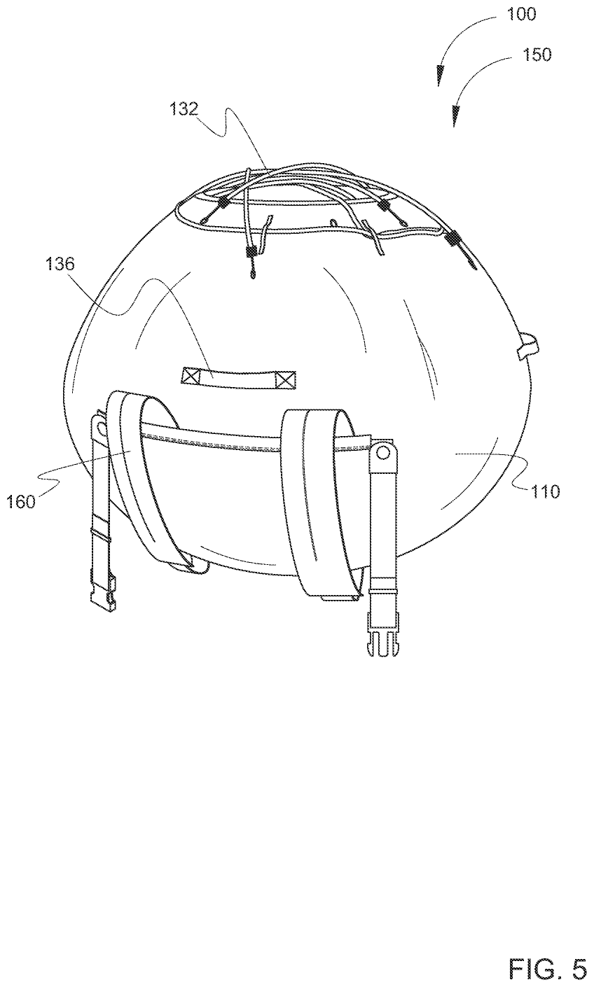

FIG. 3 is a perspective view of the strap system 130 of the debris containment bag 100 of FIG. 1, according to an embodiment of the present disclosure. As shown, the strap system 130 includes at least four bungee-style securing straps 132 comprising an elasticized material and each having fastener hooks 134, a first adjustable length securing strap 140, a second adjustable length securing strap 142, and a pair of backpack-shoulder straps 160. The strap system 130 may be used to secure the debris containment bag 100 in a plurality of configurations. The pair of backpack-shoulder straps 160 extend from a top-seam 126 of the first storage pouch 122 to a bottom-seam 128 of the first storage pouch 122 in a looped configuration. The pair of backpack-shoulder straps 160 allow a user to carry the debris containment bag 100 in a wearable, backpack-like configuration, as further shown in FIG. 5.

The first adjustable length securing strap 140 and the second adjustable length securing strap 142 each comprise mating spring-loaded buckle type fasteners. The first adjustable length securing strap 140 and the second adjustable length securing strap 142 of the debris containment bag 100 may include various types of buckles, including but not limited to buckles of the side release, spring-loaded, sliding, cam, ratchet, and snap varieties. The first adjustable length securing strap 140 and the second adjustable length securing strap 142 each include a male-fastener 144 and a female-fastener 146. The male-fastener 144 and the female-fastener 146 are positioned at opposing ends and are configured to be selectively coupled to secure the debris containment bag 100 in a selected configuration. As shown, the first adjustable length securing strap 140 extends from a top-right-seam 151 and a top-left-seam 152 of the first storage pouch 122 and the second adjustable length securing strap 142 extends from a bottom-right-seam 154 and a bottom-left-seam 156. The first storage pouch 122 and the second storage pouch 124 of the debris containment bag 100 provide additional storage capacity, allowing a user to store and carry tools, personal items, and the like.

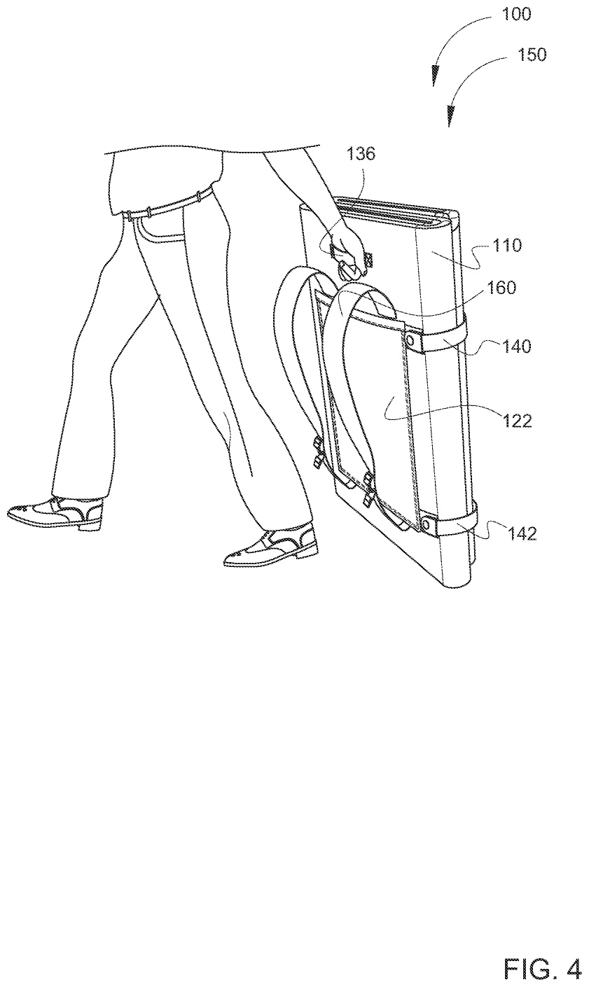

FIG. 4 is a perspective view of the debris containment bag 100 during an ‘in-use’ condition 150, according to an embodiment of the present disclosure. As illustrated, the debris containment bag 100 may be folded up and rolled using the wheel member 164. The wheel member 164 of the debris containment bag 100 eliminates a need for use of a dolly to transport collected debris. The wheel member 164 of the debris containment bag 100 may include various number of wheels of various diameters. The wheels of the wheel member 164 may also be of caster-wheel format. The debris containment bag 100 may include a firm handle to better enable use of its wheel member 164. In such variation, the firm handle may be contained with and retractable from an enclosed sleeve, and may or may not be telescoping.

FIG. 5 is a perspective view of the debris containment bag 100 during an ‘in-use’ condition 150, according to an embodiment of the present disclosure. As shown, the pair of backpack-shoulder straps 160 allow a user to transport the debris containment bag 100 upon their back in a backpack-like folded condition. By providing convenient means to transport items, the debris containment bag 100 eliminates the risk of physical stress, strain, and injury upon its user during such tasks.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A debris containment bag, the debris containment bag comprising:
a flexible canvas sheet having an octagonal profile including,
a first-side for placing at least one item for transport, and
a second-side comprising,
a strap system including,
at least four bungee-style securing straps each having fastener hooks,
a first adjustable length securing strap,
a second adjustable length securing strap,
a pair of backpack-shoulder straps, and
a wheel member positioned at a center portion of said flexible canvas sheet, and
wherein said strap system is configured to secure said flexible canvas sheet in a folded condition forming an inner volume for transport of said at least one item within said flexible canvas sheet.

2. The debris containment bag of claim 1, wherein said wheel member includes a first-wheel and a second-wheel hosted on an axle.

3. The debris containment bag of claim 2, wherein said wheel member further comprises a cover plate, said first-wheel and said second-wheel extending through said cover plate.

4. The debris containment bag of claim 3, wherein said cover plate comprises a curved profile.

5. The debris containment bag of claim 3, wherein said second-side further comprises a first storage pouch positioned proximal to a top edge of said wheel member and a second storage pouch positioned along a bottom edge of said wheel member.

6. The debris containment bag of claim 1, wherein said pair of backpack-shoulder straps extend from a top-seam of said first storage pouch to a bottom-seam of said first storage pouch in a looped configuration.

7. The debris containment bag of claim 6, wherein said pair of backpack-shoulder straps allow a user to carry said debris containment bag in a wearable, backpack-like configuration.

8. The debris containment bag of claim 1, wherein said flexible canvas sheet is foldable into a plurality of configurations.

9. The debris containment bag of claim 1, wherein said at least four bungee-style securing straps are supported by a series of support strap loops.

10. The debris containment bag of claim 9, wherein said at least four bungee-style securing straps are elasticized.

11. The debris containment bag of claim 1, wherein said second-side further comprises at least one handle.

12. The debris containment bag of claim 11, wherein said at least one handle comprises a loop.

13. The debris containment bag of claim 11, wherein said second-side comprises exactly four of said at least one handles.

14. The debris containment bag of claim 1, further comprises a plurality of grommets positioned along an outer perimeter of said flexible canvas sheet.

15. The debris containment bag of claim 14, wherein said plurality of grommets are staggered and equidistantly spaced, said plurality of grommets configured to receive one of said fastener hooks of said at least four bungee-style securing straps.

16. The debris containment bag of claim 1, wherein said first adjustable length securing strap and said second adjustable length securing strap each comprise mating spring-loaded buckle type fasteners.

17. The debris containment bag of claim 1, wherein said first adjustable length securing strap and said second adjustable length securing strap each include a male-fastener and a female-fastener, said male-fastener and said female-fastener being positioned at opposing ends.

18. The debris containment bag of claim 17, wherein said first adjustable length securing strap extends from a top-right-seam and a top-left-seam of said first storage pouch and said second adjustable length securing strap extends from a bottom-right-seam and a bottom-left-seam.

19. The debris containment bag of claim 1, wherein said flexible canvas sheet measures a maximum length of approximately seventy-two inches and a maximum width of approximately forty-eight inches.

20. A debris containment bag, the debris containment bag comprising:
a flexible canvas sheet having an octagonal profile including,
a first-side for placing at least one item for transport, and
a second-side comprising,
a strap system including,
at least four bungee-style securing straps each having fastener hooks,
a first adjustable length securing strap,
a second adjustable length securing strap,
a pair of backpack-shoulder straps, and
a wheel member positioned at a center portion of said flexible canvas sheet,
a plurality of grommets positioned along an outer perimeter of said flexible canvas sheet,
wherein said wheel member includes a first-wheel and a second-wheel hosted on an axle;
wherein said wheel member further comprises a cover plate, said first-wheel and said second-wheel extending through said cover plate;
wherein said cover plate comprises a curved profile;
wherein said second-side further comprises a first storage pouch positioned proximal to a top edge of said wheel member and a second storage pouch positioned along a bottom edge of said wheel member;
wherein said pair of backpack-shoulder straps extend from a top-seam of said first storage pouch to a bottom-seam of said first storage pouch in a looped configuration;
wherein said pair of backpack-shoulder straps allow a user to carry said debris containment bag in a wearable, backpack-like configuration;
wherein said flexible canvas sheet is foldable into a plurality of configurations;
wherein said at least four bungee-style securing straps are supported by a series of support strap loops;
wherein said at least four bungee-style securing straps are elasticized;
wherein said second-side further comprises at least one handle;
wherein said at least one handle comprises a loop;
wherein said second-side comprises exactly four of said at least one handles;
wherein said strap system is configured to secure said flexible canvas sheet in a folded condition forming an inner volume for transport of said at least one item within said flexible canvas sheet;
wherein said plurality of grommets are staggered and equidistantly spaced, said plurality of grommets configured to receive one of said fastener hooks of said at least four bungee-style securing straps;
wherein said first adjustable length securing strap and said second adjustable length securing strap each comprise mating spring-loaded buckle type fasteners;
wherein said first adjustable length securing strap and said second adjustable length securing strap each include a male-fastener and a female-fastener, said male-fastener and said female-fastener being positioned at opposing ends;
wherein said first adjustable length securing strap extends from a top-right-seam and a top-left-seam of said first storage pouch and said second adjustable length securing strap extends from a bottom-right-seam and a bottom-left-seam; and
wherein said flexible canvas sheet measures a maximum length of approximately seventy-two inches and a maximum width of approximately forty-eight inches.
